(19) United States
(12) Patent Application Publication
(10) Pub. No.: US 2009/0236003 A1
(43) Pub. Date: Sep. 24, 2009

(54) Apparatus for preventing the passage of small animals into tubular structures

(76) Inventor: Ryan William Hansen, Lake Stevens, WA (US)

Correspondence Address: Ryan William Hansen, 5022 91st Ave NE, Lake Stevens, WA, 98258, US

(21) Appl. No.: 12/079,033

(22) Filed: Mar. 24, 2008

(51) Int. Cl. F16L 57/00; A01K 15/04

(52) U.S. Cl. 138/110; 119/739

(57) ABSTRACT

An apparatus for preventing the passage of small animals into tubular structures. with a plurality of contoured sections, contoured sections fitting against inside of tubular structure, contoured sections in opposing arrangment, cylinder nubs connected to the contoured sections, threaded rods connect the contoured sections by fitting into the cylinder nubs, nuts at each end of rod, contoured sections adjusted by changing position of nuts on connecting rods, and contoured sections, cylinder nubs, threaded rods, and nuts made from a plurality of materials.

In the preferred embodiment this apparatus is installed in the exhaust outlet of a marine vessel where it prevents small animals such as muskrats, beavers, otters, and rats from entering the exhaust system. In other embodiments it would be installed it piping, hoses, duct work, drainage systems, sewer systems, where it would prevent the passage of small animals while allowing the passage of gases and fluids.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

### Description of the Prior Art

Animal pests such as mice, rats, otters, muskrats and the like often invade areas of marine vessles in order to build nest and raise offspring. Among the areas especially susceptable to invasion are any outflow tubing, such as an engine exhaust. Once inside these pest can cause significant damage by biting, scratching and excreting waste matter. For example, rodent pests are known to invade the engine exhaust systems in boats. In extreme cases they will then chew through the exhaust tubing which allows water to flood into the vessel and results in the vessels sinking. This problem has taken on new characteristics in the last few years as the bronze exhaust system tubing of the past has been replaced with plastic materials which are more vulnerable to the animal pests chewing.

For this reason, it is imperative to have a means to protect marine vessels and other similar items against infestations of these damaging animals through inflow and/or outflow tubing. Especially critical is having a means of preventing animal pests from entering a marine vessel through it's engine exhaust tubing.

Over the years a variety of devices have been developed, which prevent or inhibit animal pests from entering various and sundry items. There are devices to prevent animal pests from entering gardens, homes, and automobiles, and some developed to keep pests from entering into ships. However, suprisingly little development has occurred where the goal is to keep animals from entering marine exhaust systems or similar inflow/outflow systems. No patent was found which directly addresses this problem. In the public domain, the company W.H. Salisbury & Co., along with other companies, offers an “Exhaust Guard Cover” which fits over exhaust pipe and for which the stated purpose is to prevent following seas from entering the exhaust system when the vessel is stopped or moving slowly. This cover is comprised of a black rubber material which covers the intake and is attached to the exhaust pipe by clamping the material to the outside surface of the exhaust pipe using a stainless steel pipe clamp. Though this device will perform it's intended task it can potentially be very difficult and costly to install when the exhaust pipe if essentially flush with the boat surface.

Representative examples of devices which prevent or inhibit animal pest penetration are disclosed in:

U.S. Pat. No. 5,570,652 to Ferland, which uses a falt clamped disk on a cylindrical sleeve.

U.S. Pat. No. 5,669,187 to Bushong, which uses a flanged barrier wall

U.S. Pat. No. 5,771,641 to Morris, which uses an interlocking wall

U.S. Pat. No. 6,550,409 to Smith, which has a ring which attaches to mooring lines and prevents a rat from entering the moored vessel.

Other representative examples of pest prevention devices are: U.S. Pat. No. 425,890 to Landis, U.S. Pat. No. 817,508 to Niele, U.S. Pat. No. 1,879,375 to McElroy, U.S. Pat. No. 2,721,633 to Keelor, U.S. Pat. No. 4,934,093 to Yanna, U.S. Pat. No. 4,969,289 to Trifiletti, U.S. Pat. No. 4,976,063 to Young, U.S. Pat. No. 6,098,348 to Weaver.

Representative examples of devices which obtain some of their intended function by using expansion inside of a tubular structure are disclosed in:

U.S. Pat. No. 6,991,461 to Gittleman, uses a dental implant with flexible expansion ribs to provide support for a dental prosthesis

U.S. Pat. No. 6,935,423 to Kusmer, uses expandable members to grip the sides of a borehole and along with a medial member acts as a retention device, which allows the passage of fluids through it.

U.S. Pat. No. 7,011,679 to Lauterjung, uses an annular clamping ring which may be folded along a diametric axis for insertion into the body passage, and which holds a prosthesis.

While these prior art devices appear to be satisfactory in use for the specific purposes for which they were designed, none of them addresses the problem of preventing animal pest infestation of a marine exhaust system using a conveniently installed device. Consequently, a need still exists for a device which provides a solution to the aforementioned problem.

### BRIEF SUMMARY OF THE INVENTION

The primary object of the invention is to provide an apparatus which prevents small animals from passing into exhaust piping.

Another object of the invention is to provide an apparatus which prevents small animals from passing through tubular structures.

Another object of the invention is to provide an apparatus which prevents small animals from passing through piping of any shape.

Another object of the invention is to provide an apparatus which is simple and easy to install.

A further object of the invention is to provide an apparatus which is installed using only common tools.

Yet another object of the invention is to provide an apparatus which requires no modification of existing structure for installation.

Still yet another object of the invention is to provide an apparatus which can be installed without special skills or training.

Another object of the invention is to provide an apparatus which resist corrosion and decay.

Another object of the invention is to provide an apparatus which prevents small animals from entering marine exhaust systems.

A further object of the invention is to provide an apparatus which does no harm to the environment or small animals.

Other objects and advantages of the present invention will become apparent from the following descriptions, an embodiment of the present invention is disclosed.

In accordance with a preferred embodiment of the invention, there is disclosed an apparatus for preventing the passage of small animals into tubular structures. comprising: a plurality of contoured sections, contoured sections fitting against inside of tubular structure, contoured sections in opposing arrangment, cylinder nubs connected to the contoured sections, threaded rods connect the contoured sections by fitting into the cylinder nubs, nuts at each end of rod, contoured sections adjusted by changing position of nuts on connecting rods, and contoured sections, cylinder nubs, threaded rods, and nuts made from a plurality of materials.

### DETAILED DESCRIPTION OF THE PREFERRED EMBODIMENT

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. It is believed that the preferred embodiment is sufficiently simple that drawings should not be required to understand the invention in either its preferred embodiment or other manifestations.

The apparatus fits inside of a tubular structure, such as a boat marine engine exhaust pipe, and is held in place by threaded rods which push two opposing contoured sections apart and hold them firmly against the inside of the tubular structure. The outside edge of the contoured sections are constructed to approximate the curvature of the inside surface of the tubular section and so the inside of the tubular structure and the outside of the invention fit closely together. The inside edge of the contoured sections contain nubs and these nubs have shallow holes into which the ends of the threaded rods will fit. Nuts on the threaded rods can be turned to push against the nubs resulting in the opposing contoured sections being pushed apart and against the inside of the tubular structure. Therefore the nuts turned on the threaded rods pushing against the nubs creates mechanical pressure at the boundary between the interior of the tubular structure and the exterior of the invention which holds the invention in place. The rod spacing is small enough that small animals are unable to pass between them, however, the rod spacing is large enough to allow the passage of gases and fluids.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An apparatus for preventing the passage of small animals into tubular structures. comprising:
(a) a plurality of contoured sections;
(b) exterior edge of contoured sections fitting against inside of tubular structure;
(c) contoured sections in opposing arrangment;
(d) interior edge of contoured sections containing cylindrical nubs;
(e) threaded rods push fitting into the cylindrical nubs;
(f) nuts at each end of rod which fit against cylindrical nubs;
(g) contoured sections adjusted by changing position of nuts on connecting rods pushing against cylindrical nubs;
(h) contoured sections being held in place against inside of tubular structure through pressure exerted by nuts turned against cylindrical nubs; and
(i) contoured sections, cylinder nubs, threaded rods, and nuts made from a plurality of materials.

2. An apparatus which prevents the passage of animals into tubular structures in which rods, which hold the apparatus in place inside the tubular structure, are the very means which prevent the passage of the animals, since the rods are spaced close enough to prevent the animal passage.

3. An apparatus as in claim 2 which is installed in a tubular structure by expanding the rods so that pressure is applied radially by the apparatus against the inner surface of the tubular structure.

4. An apparatus as in claim 2 which is held in place by the pressure exerted by the apparatus against the inner surface of the tubular structure.

5. An apparatus as in claim 2 which is held in place by both pressure exerted by the apparatus against the inner surface of the tubular structure, and by abrasive material between the apparatus and said inner surface.

6. An apparatus as in claim 2 which is held in place by the pressure exerted by the apparatus against the inner surface of the tubular structure and where the pressure is produced by compressed springs.

7. An apparatus as in claim 2 which is held in place by the pressure exerted by the apparatus against the inner surface of the tubular structure and where the pressure is produced by bending of the material which comprises the rods.
